(19) United States
(12) Patent Application Publication
(10) Pub. No.: US 2014/0280135 A1
(43) Pub. Date: Sep. 18, 2014

(54) TIME-SERIES DATA ANALYZING APPARATUS AND TIME-SERIES DATA ANALYZING METHOD

(71) Applicant: YAHOO JAPAN CORPORATION, Tokyo (JP)

(72) Inventor: Kota TSUBOUCHI, Tokyo (JP)

(73) Assignee: YAHOO JAPAN CORPORATION, Tokyo (JP)

(21) Appl. No.: 14/158,008

(22) Filed: Jan. 17, 2014

(30) Foreign Application Priority Data
Mar. 13, 2013 (JP) 2013-049852

(51) Int. Cl. G06F 17/30

(52) U.S. Cl. CPC G06F 17/30289
USPC 707/736

(57) ABSTRACT

A time-series data analyzing apparatus includes an observation data storing unit, a feature amount data obtaining unit, a state rule obtaining unit, an action rule obtaining unit, and an output unit. The observation data storing unit stores one or more types of observation data in time series which are observation data of an object for observation. The feature amount data obtaining unit obtains two or more types of feature amount data from one type of the observation data. The state rule obtaining unit obtains a state rule which is a rule related to a state of the object, by using the feature amount data. The action rule obtaining unit obtains an action rule which is a rule related to an action of the object, by using the feature amount data. The output unit outputs the state rule and the action rule.

### CROSS-REFERENCE TO RELATED APPLICATIONS

The present application claims priority to and incorporates by reference the entire contents of Japanese Patent Application No. 2013-049852 filed in Japan on Mar. 13, 2013.

### BACKGROUND OF THE INVENTION

1. Field of the Invention

The present invention relates to a time-series data analyzing apparatus and the like for analyzing data in time series.

2. Description of the Related Art

Apparatuses have been developed which obtain regularity from data in time series (for example, Japanese Laid-open Patent Publication No. 2006-338373).

However, there is a problem with the apparatus for analyzing data in time series that only one type of feature amount data are obtained from one type of data in time series, and thus the data in time series are not effectively used.

### SUMMARY OF THE INVENTION

It is an object of the present invention to at least partially solve the problems in the conventional technology.

According to one aspect of an embodiment, a time-series data analyzing apparatus includes: an observation data storing unit configured to store one or more types of observation data in time series which are observation data of an object for observation; a feature amount data obtaining unit configured to obtain two or more types of feature amount data which are time series data of characteristic values, from one type of the observation data stored in the observation data storing unit; a state rule obtaining unit configured to obtain a state rule which is a rule related to a state of the object, by using the feature amount data; an action rule obtaining unit configured to obtain an action rule which is a rule related to an action of the object, by using the feature amount data; and an output unit configured to output the state rule obtained by the state rule obtaining unit and the action rule obtained by the action rule obtaining unit.

According to another aspect of an embodiment, a time-series data analyzing method includes: firstly obtaining two or more types of feature amount data which are time series data of characteristic values, from one type of the observation data stored in an observation data storing unit, the observation data storing unit storing one or more types of observation data in time series which are observation data of an object for observation; secondly obtaining a state rule which is a rule related to a state of the object, by using the feature amount data; thirdly obtaining an action rule which is a rule related to an action of the object, by using the feature amount data; and outputting the state rule obtained in the secondly obtaining and the action rule obtained in the thirdly obtaining.

According to still another aspect of an embodiment, a computer-readable recording, medium having stored therein a program, the program causing a computer to execute a process which includes: firstly obtaining two or more types of feature amount data which are time series data of characteristic values, from one type of observation data stored in an observation data storing unit, the observation data storing unit storing one or more types of observation data in time series which are observation data of an object for observation; secondly obtaining a state rule which is a rule related to a state of the object, by using the feature amount data; thirdly obtaining an action rule which is a rule related to an action of the object, by using the feature amount data; and outputting the state rule obtained in the secondly obtaining and the action rule obtained in the thirdly obtaining.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a time-series data analyzing apparatus of a first embodiment;

FIG. 2 is diagram illustrating an example of observation data stored in an observation data storing unit of the embodiment;

FIG. 3 is a diagram for describing how a feature amount data obtaining unit of the embodiment obtains feature amounts;

FIG. 4 is a diagram for describing how a state label setting unit and an action label setting unit of the embodiment set labels;

FIG. 5 is a diagram for describing how a state rule obtaining unit and an action rule obtaining unit of the embodiment obtain the rules;

FIG. 6 is a flow chart illustrating an operation of a time-series data analyzing apparatus of the embodiment;

FIG. 7 is a diagram illustrating an example of an external appearance of a computer system of the embodiment; and

FIG. 8 is a diagram illustrating an example of a configuration of the computer system of the embodiment.

### DETAILED DESCRIPTION OF THE PREFERRED EMBODIMENTS

The embodiment of a time-series data analyzing apparatus and the like will be described below with reference to the drawings. A component having the same reference numeral operates in the same manner in the embodiment, and the description thereof may not be repeated.

### First Embodiment

In this embodiment, a time-series data analyzing apparatus 1 will be described which obtains a rule related to a state and a rule related to an action from observation data in time series. FIG. 1 is a block diagram of a time-series data analyzing apparatus 1 of the embodiment.

The time-series data analyzing apparatus 1 includes an observation data storing unit 101, a feature amount data obtaining unit 102, a state rule obtaining unit 103, an action rule obtaining unit 104, and an output unit 105. The state rule obtaining unit 103 includes a state label setting unit 21 and a state rule identifying unit 22. The action rule obtaining unit 104 includes an action label setting unit 23 and an action rule identifying unit 24.

The observation data storing unit 101 stores one or more types of observation data in time series which are observation data of an object for observation. In the following, the observation data of an object for observation can be referred to as “object observation data.” The object for observation is preferably an object which acts on its own, but may be an object other than what acts on its own. An object which acts on its own is preferably an animal, for example; however, the object may be a plant or a human, or may not be a human. The object other than what acts on its own may be a vehicle or a tool having a moving part and the like, for example. A set of observation data in time series are serial data obtained by various types of sensors at predetermined intervals. The predetermined interval may be constant or may not be constant. The predetermined interval may be once in one second or once in 10 seconds, for example. The predetermined interval only has to be equal to or shorter than an interval required to obtain the state rule or the action rule.

As the object observation data in time series, preferable are a motion picture of an object for observation taken by a camera, a sound emitted by the object for observation and collected by a microphone, and the like; but any data obtained by using various types of sensors are acceptable. For example, the object observation data in time series may be data in time series representing body temperatures measured by a thermography, time-series data of positions obtained by a GPS mounted on the object, data in time series representing angles of the object obtained by a gyro sensor mounted on the object, or time-series data of heart rates obtained by a sphygmometer mounted on an animal as the object for observation. Here, the sound emitted by the object for observation may be a sound such as a call emitted by the object for observation or a sound generated due to the action of the object for observation. The sound created due to the action of the object for observation may be, for example, a sound when a squirrel is cracking sunflower seeds, a splash sound when a raccoon washes food, a squeaking sound which a car tire and a road surface create, or the like. Further, the object observation data obtained by using a various types of sensors may be the data obtained by using the various types of sensors and not processed or may be data calculated from the data obtained by using the various types of sensors. The object observation data which are the data calculated from the data obtained by using the sensors may be, for example, three dimensional coordinate data in time series which are obtained by using two of more video cameras and indicate a history of movement of the object for observation, for example.

In addition, the observation data storing unit 101 may store observation data in time series about an external environment. The observation data related to an external environment can be referred to as “external environment observation data.” The object observation data and the external environment observation data can be generally referred to as “observation data.” The external environment is a phenomenon related to a surrounding environment of the object for observation. As the surrounding environment, any environment within a zone influencing the object for observation can be used. The surrounding environment may be a peripheral of an object's cage, a room in which the cage is placed, or the like. The external environment observation data may be any data about the external environment obtained by using a various types of sensors. For example, the external environment observation data in time series may be a motion picture taken by a camera, data in time series indicating sound collected by a microphone, data in time series indicating atmospheric temperatures obtained by a thermometer, data in time series indicating amounts of precipitation obtained by a rain gauge, data in time series indicating air pressures obtained by a barometer, data in time series indicating wind strength obtained by an anemometer, or the like. Further, the external environment observation data obtained by using a various types of sensors may be the data obtained by using the various types of sensors and not processed, or may be data calculated from the data obtained by using the various types of sensors. Further, the external environment observation data which are the data calculated from the data obtained by using sensors may be data in time series which, for example, are calculated from a temperature history obtained by a thermometer and indicate temperature differences between the present and a few hours ago, or may be data in time series which indicate temperature differences calculated from the temperatures, inside and outside a room, obtained by two or more thermometers. Since the sensors to be used to obtain the object observation data and the external environment observation data are all known techniques, their detailed descriptions will not be made.

The observation data storing unit 101 may store two or more types of object observation data in time series. When two or more types of object observation data in time series are stored in the observation data storing unit 101, the observation data storing unit 101 stores the sets of observation data as shown in FIG. 2, for example. The sets of observation data stored in the observation data storing unit 101 each include a common period of time. In other words, it is preferable to store two or more types of observation data in time series observed in an arbitrary period of time, from 00:00:00 to 00:00:05 on Jan. 1, 2013, for example. Further, it is preferable that the observation data storing unit 101 stores the data such that pieces of information of respective sets of observation data in time series at a predetermined time in the common period of time can be synchronized with each other. In order to synchronize the sets of observation data in time series, each set of observation data in time series may have information such as a time code required for synchronization. A description will be made below mainly based on the case that the observation data storing unit 101 stores two types of object observation data and one type of external environment observation data. The observation data storing unit 101 is preferably a nonvolatile recording medium, but a volatile recording medium can be used. The observation data may be stored in the observation data storing unit 101 in any manner. For example, the observation data may be stored in the observation data storing unit 101 through a recording medium; the observation data may be transmitted through a communication line or the like to be stored in the observation data storing unit 101; alternatively, the observation data may be input through an input device to be stored in the observation data storing unit 101. Here, the expression “two or more types of observation data” represents observation data obtained by using two or more types of sensors.

The feature amount data obtaining unit 102 obtains two or more types of feature amount data as time series data of characteristic values, from one type of object observation data stored in the observation data storing unit 101. Further, the feature amount data obtaining unit 102 may obtain external environment feature amount data as the time series data of characteristic values, also from the observation data in time series about the external environment. The feature amount data are data in which observation data are divided by a predetermined period, and the characteristic values in respective periods are arranged in time series as shown in FIG. 3, for example. The values of feature amount data may be the maximum values in the predetermined periods, the minimum values in the predetermined periods, average values in the predetermined periods, gradients of a waveform in the predetermined period, characteristic values obtained by Fourier-transforming the waveforms in the predetermined periods, values obtained by time-differentiating displacements in the predetermined periods, values obtained by time-differentiating twice the displacements in the predetermined periods, or values and the like obtained by other algorithms. Alternatively, the feature amount data may be values corresponding to the values obtained as described above. For example, the feature amount data obtaining unit 102 may use a correspondence table stored in a storing unit (not shown in the drawings) to obtain the values of the feature amount data corresponding to respective values obtained as described above. In particular, the feature amount data obtaining unit 102 may obtain the feature amount data about volume of sound of a call by using a correspondence table in which values of the feature amount data are classified into five levels depending on volume of the sound. The values of the feature amount data may be values obtained by rounding an arbitrary digit of the values obtained as described above. The method of the rounding may be half-adjust, round-down, or round-up.

When the observation data storing unit 101 stores two or more types of observation data in time series of an object for observation, the feature amount data obtaining unit 102 may obtain three or more types of feature amount data from the two or more types of object observation data of the object for observation stored in the observation data storing unit 101. When the feature amount data obtaining unit 102 obtains the feature amount data from the two or more types of object observation data in time series, the feature amount data obtaining unit 102 may obtain two or more types of feature amount data from one type of object observation data, and may obtain one or more types of feature amount data from each of the types of object observation data which do not include the one type of object observation data. In other words, the feature amount data obtaining unit 102 may obtain (M+1) or more types of feature amount data from M types of object observation data by using each of the M types of object observation data. Here, the number M is a natural number equal to or greater than one. Thus, it may be considered that the object observation data used for obtaining the feature amount data not used for obtaining the state rule or the action rule are not included in the M types of object observation data. In the following, a description will be made mainly in the case that the observation data storing unit 101 stores two or more types of object observation data in time series.

The feature amount data obtaining unit 102 may obtain state feature amount data, which are the feature amount data about state, and may obtain action feature amount data, which are the feature amount data about action, from the object observation data; however the feature amount data obtaining unit 102 does not have to do so. Note that, when the observation data storing unit 101 stores two or more types of observation data in time series of the object for observation, the feature amount data obtaining unit 102 may obtain N or more types of state feature amount data and (3-N) or more types of action feature amount data, from the object observation data. The number N is one or two. The state feature amount data may be a plurality of pieces of data arranged in a line to be used to obtain the state rule. The state rule is information about the state of the object and is made up of a plurality of values of the feature amount data arranged in a line, the labels, or the like. Hereinafter, the plurality of values arranged sequentially or in a line may be referred to as “a line of values.” The state rule may be, for example, information to indicate the state of feeding, information to indicate the state of drinking water, information to indicate the state of urinating, information to indicate the state of defecating, information to indicate the state of sleeping, or information to indicate other states. In addition, the action feature amount data may be data to be used to obtain the action rule. The action rule is information about the action of the object and is made up of a plurality of values of the feature amount data arranged in a line, the labels, or the like. The action rule may be, for example, information to indicate the action of changing positions on a regular basis, information to indicate the action of running, information to indicate the action of making a call, information to indicate the action of jumping, or the like. The difference between the state feature amount data and the action feature amount data may be in that the object observation data are divided, in the process for obtaining the feature amount data, by a different predetermined period, in that the feature amount data are obtained in a different process, in that the feature amount data are obtained from different object observation data, or in the combination of two or more of the above differences. In the case that the predetermined periods by which the object observation data are divided are different, the difference may be in that the predetermined period in the process for obtaining the state feature amount data is shorter than the predetermined period in the process for obtaining the action feature amount data. For example, when the predetermined period in the process for obtaining the state feature amount data is 10 seconds, the predetermined period in the process of obtaining the action feature amount data may be one second. In the case that the process for obtaining the feature amount data is different, the difference may be in that, for example, when the process for obtaining the state feature amount data is a process for obtaining integral values, the process for obtaining the action feature amount data is obtaining differential values. In the case that the object observation data from which the feature amount data are different, the difference may be in that the object observation data to be used to obtain the state feature amount data and the object observation data to be used to obtain the action feature amount data are previously made to be different. For example, the processes in the feature amount data obtaining unit 102 may be previously made to obtain the state feature amount data and the action feature amount data from a camera, and the action feature amount data from a microphone, for example.

Alternatively, the “two or more types of feature amount data” may be considered to be two or more sets of feature amount data each obtained by different processes. Note that in the case that the two sets of feature amount data obtained by different processes are the same feature amount data, these sets of feature amount data may be considered two types of feature amount data obtained by different processes, or may be considered one type of feature amount data. The feature amount data obtaining unit 102 can be generally realized by an MPU, a memory, and the like. A procedure in the feature amount data obtaining unit 102 is generally realized by software, and the software is recorded in a recording medium such as a ROM. However, the procedure may be realized by hardware (dedicated circuit).

The state rule obtaining unit 103 obtains the state rule which is the rule related to the state of the object by using the one or more types of feature amount data obtained by the feature amount data obtaining unit 102. In the case that the feature amount data obtaining unit 102 has obtained two or more types of feature amount data from one type of object observation data, the state rule obtaining unit 103 may obtain the state rule by using at least one or more of the two or more types of feature amount data. In the case of obtaining the state rule from one type of feature amount data, when two or more consecutive values repeatedly appear in the feature amount data in a predetermined period, the state rule obtaining unit 103 may obtain the state rule which is the values of the consecutive feature amount data. Alternatively, when the feature amount data obtaining unit 102 has obtained three or more types of feature amount data from two or more types of object observation data in time series, the state rule obtaining unit 103 may obtain the state rule by using any N or more types of feature amount data of the three or more types of feature amount data. The number N is one or two as described above. In the case of obtaining the state rule from two or more types of feature amount data, when a combination of one value or consecutive two or more values repeatedly appears in the two or more types of feature amount data in a predetermined period, the state rule obtaining unit 103 may obtain the state rule which is the combination of the consecutive values. Further, when the feature amount data obtaining unit 102 has obtained the state feature amount data, the state rule obtaining unit 103 may obtain the state rule from the state feature amount data in the above-described manner.

Further, the state rule obtaining unit 103 may obtain the state rule for each of the values of the external environment feature amount data, or for each of the classes of the values of the external environment feature amount data. The expression “to obtain the state rule for each of the values of the external environment feature amount data” means to obtain the state rule for each of the values obtained by the feature amount data obtaining unit 102. For example, in the case that the external environment observation data are the observation data about the atmospheric temperature, the state rule obtaining unit 103 may obtain both of the state rule for the atmospheric temperature of 30 degrees and the state rule for the atmospheric temperature of 31 degrees. The expression “to obtain the state rule for each of the classes of the values of the external environment feature amount data” means to classify the values obtained by the feature amount data obtaining unit 102 into two or more classes and obtain the state rule for each of the classes. For example, in the case that the external environment observation data are the observation data about the atmospheric temperature, the state rule obtaining unit 103 may obtain both of the state rule for the atmospheric temperature of 30 degrees or higher and the state rule for the atmospheric temperature of 20 degrees or higher and lower than 30 degrees. The classification of the values of the external environment feature amount data may be performed in a manner other than the above-described manners. In the case that the external environment observation data are the observation data about amounts of precipitation, the classes may represent whether it is raining or not, and in the case that the external environment observation data are the observation data about sound, the classes may represent a library noise level, a household noise level, or a construction site noise level. The state rule obtaining unit 103 can be realized by an MPU, a memory, and the like, in general. The procedure in the state rule obtaining unit 103 is generally realized by software, and the software is recorded in a recording medium such as a ROM. However, the procedure may be realized by hardware (dedicated circuit).

The state rule obtaining unit 103 may give labels to the feature amount data by using the processes of the state label setting unit 21 and the state rule identifying unit 22, and may then obtain the state rule. The above-described feature amount data may be the state feature amount data. The state label setting unit 21 classifies the values of the feature amount data into a plurality of groups as shown in FIG. 4, and sets the same state label to the values of the feature amount data belonging to the same group. The state label setting unit 21 may set the state label to any N or more types of the feature amount data of the three or more types of feature amount data. The number N is one or two as described above. According to any standard, the state label setting unit 21 may classify the values of the feature amount data. For example, the state label setting unit 21 may classify the values of the feature amount data into groups each of which corresponds to each value, may classify the values of the feature amount data into groups each of which corresponds to a predetermined range of value, or may classify the values of the feature amount data into groups according to a previously determined rule. The previously determined rule may be a rule for classifying the values into the group of even values of the feature amount data and the group of odd values of the feature amount, or may be a rule for classifying the values into the group of frequently appearing values of the feature amount data and the group of other values of the feature amount data. The state label is information based on which the classified group can be identified. In other words, any type of information can be used as the state label if the group can be uniquely identified. By using the state label, the values of a plurality of feature amount data can be assigned to one label, whereby the information can be further rounded than by using the value of the feature amount data. That is, setting of the state label makes it easy to find the state rule.

The state label setting unit 21 may classify the values of two or more consecutive feature amount data together into one group. When the state label setting unit 21 has classified the values of two or more consecutive feature amount data together into one group, one state label may be set to the values of the two or more consecutive feature amount data. In particular, the state label setting unit 21 may put together a line of the values of the feature amount data “the value of the feature amount data indicating an active state, the value of the feature amount data indicating an inactive state, the value of the feature amount data indicating an inactive state, the value of the feature amount data indicating an active state” into a line of the values of the feature amount data “the value of the feature amount data indicating an active state, the value of the feature amount data indicating an inactive state, the value of the feature amount data indicating an active state,” for example. By putting together the values of the feature amount data, in the above-described case, for example, the state label setting unit 21 can set labels regardless of the length of the period of the inactive state.

The state rule identifying unit 22 obtains the state rule from, for example, the line of N or more types of state labels set by the state label setting unit 21 as shown in FIG. 5. In the case of obtaining the state rule based on a line of one type of state labels, when two or more consecutive state labels appear in that line of state labels in a predetermined period, the state rule identifying unit 22 may obtain the state rule which is the consecutive state labels. Alternatively, in the case of obtaining the state rule based on a line of two or more types of state labels, when a combination of one state label or consecutive two or more state labels repeatedly appears in the line of two or more types of state labels in a predetermined period, the state rule identifying unit 22 may obtain the state rule which is the combination of the consecutive state labels. The state rule identifying unit 22 may obtain the state rule by, for example, dividing a line of state labels into a plurality of periods and conducting frequent-pattern mining, or may obtain the state rule by dividing the line of state labels a plurality of times with varying the divided periods and similarly conducting frequent-pattern mining. Since the frequent-pattern mining is a known technique, a detailed description thereof will not be made. The state rule identifying unit 22 can be realized by an MPU, a memory, and the like, in general.

The action rule obtaining unit 104 obtains the action rule, which is a rule related to the action of the object, by using the one or more types of feature amount data obtained by the feature amount data obtaining unit 102. In the case that the feature amount data obtaining unit 102 has obtained two or more types of feature amount data from one type of object observation data, the action rule obtaining unit 104 may obtain the action rule by using at least one or more of the two or more types of feature amount data. In the case of obtaining the action rule from one type of feature amount data, when two or more consecutive values repeatedly appear in the feature amount data in a predetermined period, the action rule obtaining unit 104 may obtain the action rule which is the values of the consecutive feature amount data. Note that when the feature amount data obtaining unit 102 has obtained three or more types of feature amount data from two or more types of object observation data in time series, the action rule obtaining unit 104 may obtain the action rule by using any (3-N) types of feature amount data of the three or more types of feature amount data. The number N is one or two as described above. In the case of obtaining the action rule from two or more types of feature amount data, when a combination of one value or consecutive two or more values repeatedly appears in the two or more types of feature amount data in a predetermined period, the action rule obtaining unit 104 may obtain the action rule which is the combination of the consecutive values. Further, when the feature amount data obtaining unit 102 has obtained the action feature amount data, the action rule obtaining unit 104 may obtain the action rule from the action feature amount data. The action rule obtaining unit 104 may obtain the action rule by using all the sets of feature amount data which are of the sets of feature amount data obtained by the feature amount data obtaining unit 102 and were not used by the state rule obtaining unit, may obtain the action rule by using at least one or more sets of feature amount data which are different in a part from the type of the feature amount data used by the state rule obtaining unit 103, or may obtain the action rule by using one or more sets of feature amount data which satisfy the above two cases. In other words, the state rule obtaining unit 103 and the action rule obtaining unit 104 may perform processes such that all the sets of feature amount data obtained by the feature amount data obtaining unit 102 are used to obtain any one of the state rule and the action. Further, the action rule may be a rule in the period in which the state rule was obtained. In particular, when the state rule obtaining unit 103 has obtained the state rule in the period x which is from time t to time (t+x), the action rule obtaining unit 104 may obtain the action rule for a period shorter than the period x in the time period from time t to time (t+x). The period x is an arbitrary period of time.

Further, the action rule obtaining unit 104 may obtain the action rule for each of the values of the external environment feature amount data or each of the classes of the values of the external environment feature amount data. The expression “to obtain the action rule for each of the values of the external environment feature amount data” means to obtain the action rule for each of the values obtained by the feature amount data obtaining unit 102. For example, in the case that the external environment observation data are the observation data about the atmospheric temperature, the action rule obtaining unit 104 may obtain each of the action rule for the atmospheric temperature of 30 degrees and the action rule for the atmospheric temperature of 31 degrees. The expression “to obtain the action rule for each of the classes of the values of the external environment feature amount data” means to classify the values obtained by the feature amount data obtaining unit 102 into two or more classes and obtain the action rule for each of the classes. For example, in the case that the external environment observation data are the observation data about the atmospheric temperature, the action rule obtaining unit 104 may obtain each of the action rule for the atmospheric temperature of 30 degrees or higher and the action rule for the atmospheric temperature of 20 degrees or higher and lower than 30 degrees. The classification of the values of the external environment feature amount data may be performed in a manner other than the above-described manners. The case that the external environment observation data are the observation data about an amount of precipitation, the classes may represent whether it is raining or not, and in the case that the external environment observation data are the observation data about sound, the classes may represent a library noise level, a household noise level, or a construction site noise level. The action rule obtaining unit 104 can be realized by an MPU, a memory, and the like, in general. The procedure in the action rule obtaining unit 104 is generally realized by software, and the software is recorded in a recording medium such as a ROM. However, the procedure may be realized by hardware (dedicated circuit).

The action rule obtaining unit 104 may give labels to the feature amount data by using the processes of the action label setting unit 23 and the action rule identifying unit 24, and may then obtain the state rule. The above-described feature amount data may be the action feature amount data. The action label setting unit 23 classifies the values of the feature amount data into a plurality of groups as shown in FIG. 4, and sets the same action label to the values of the feature amount data belonging to the same group. The action label setting unit 23 may set the action label to any (3-N) or more types of the feature amount data of the three or more types of feature amount data. The number N is one or two as described above. According to any standard, the action label setting unit 23 may classify the values of the feature amount data. For example, the action label setting unit 23 may classify the values of the feature amount data into groups each of which corresponds to each value, may classify the values of the feature amount data into groups each of which corresponds to a predetermined range of value, or may classify the values of the feature amount data into groups according to a previously determined rule. The previously determined rule may be a rule for classifying the values into the group of even values of the feature amount data and the group of odd values of the feature amount, or may be a rule for classifying the values into the group of frequently appearing values of the feature amount data and the group of other values of the feature amount data. The action label is information based on which the classified group can be identified. In other words, any type of information can be used as the action label if the group can be uniquely identified. By using the action label, the value of a plurality of feature amount data can be assigned to one label, whereby the information can be further rounded than by using the value of the feature amount data. That is, setting of the action label makes it easy to find the action rule.

The action label setting unit 23 may classify the values of two or more consecutive feature amount data together into one group. When the action label setting unit 23 has classified the values of two or more consecutive feature amount data together into one group, one action label may be set to the values of the two or more consecutive feature amount data. In particular, the action label setting unit 23 may put together a line of the values of the feature amount data “the value of the feature amount data indicating a running action, the value of the feature amount data indicating a walking action, the value of the feature amount data indicating a walking action, the value of the feature amount data indicating a running action” into a line of the values of the feature amount data “the value of the feature amount data indicating a running action, the value of the feature amount data indicating a walking action, the value of the feature amount data indicating a running action,” for example. By putting together the values of the feature amount data, in the above-described case, for example, the action label setting unit 23 can set labels regardless of the length of the period of walking.

The action rule identifying unit 24 obtains the action rule from, for example, the line of (3-N) or more types of action labels set by the action label setting unit 23 as shown in FIG. 5. The number N is one or two as described above. In the case of obtaining the action rule based on a line of one type of action labels, when two or more consecutive action labels appear in that line of action labels in a predetermined period, the action rule identifying unit 24 may obtain the action rule which is the consecutive action labels. Alternatively, in the case of obtaining the action rule based on a line of two or more types of action labels, when a combination of one action label or consecutive two or more action labels repeatedly appears in the line of two or more types of action labels in a predetermined period, the action rule identifying unit 24 may obtain the action rule which is the combination of the consecutive action labels. The action rule identifying unit 24 may obtain the action rule by, for example, dividing a line of action labels into a plurality of periods and conducting frequent-pattern mining, or may obtain the action rule by dividing the line of action labels a plurality of times with varying the divided periods and similarly conducting frequent-pattern mining. The action rule identifying unit 24 can be realized by an MPU, a memory, and the like, in general.

The output unit 105 outputs the state rule obtained by the state rule obtaining unit 103 and the action rule obtained by the action rule obtaining unit 104. The output unit 105 outputs the state rule and the action rule for each of the external environment feature amount data and each of the classes of the values of the external environment feature amount data. The output unit 105 may outputs the state rule and the action rule including the same period, putting the state rule and the action rule in correspondence with each other. To output the state rule and the action rule in correspondence with each other may mean to simultaneously output the state rule and the action rule, may mean to output separately the state rule, the action rule, and the action rule which include the same ID, or may mean to output the state rule and the action rule serially. Alternatively, the output unit 105 may output the state rule and the action rule, putting the state rule and the action rule in correspondence with the value of the external environment feature amount data or the class of the values of external environment feature amount data, in the similar manner described above. Note that the output unit 105 may output the state rule and the action rule only when the state rule and the action rule in the period when the state rule was obtained are both obtained, or when only one of the state rule and the action rule is obtained. The “output” is a concept including display on a display device, projection using a projector, print by a printer, sound output, transmission to an external device, accumulation in a recording medium, supply of a processed result to other processing devices or other programs, and the like. The output unit 105 may or may not be considered to include an output device such as a display and a speaker. The output unit 105 can be realized by a driver software for an output device or by a driver software of an output device and an output device, or the like.

The time-series data analyzing apparatus 1 obtains the state rule and the action rule as described above. The thus obtained rules are used in an apparatus and the like for classifying data based on a state and an action of an object by using the rules. The apparatus and the like for classifying data based on a state and an action of an object by using a rule may be, for example, an apparatus storing therein data which put the rules about an animal in correspondence with information about diseases indicated by the rules, and upon receiving object observation data about an animal, the rule made in correspondence with the object observation data is searched, and when the rule is found, the information about the disease related to the rule is transmitted.

FIG. 6 is a flow chart illustrating an example of operation of the time-series data analyzing apparatus 1 of the embodiment. In the following, the operation will be described with reference to FIG. 6. With reference to the flow chart, the description will be made in the case that the observation data storing unit 101 stores two types of observation data of an object for observation.

Step S201: The feature amount data obtaining unit 102 obtains three or more types of feature amount data from the two types of object observation data stored in the observation data storing unit 101.

Step S202: The feature amount data obtaining unit 102 obtains external environment feature amount data from external environment observation data stored in the observation data storing unit 101.

Step S203: The state label setting unit 21 classifies the feature amount data obtained in step S201 into groups for each of the values of the feature amount data, and sets a state label to each of the classified groups.

Step S204: The state rule identifying unit 22 identifies a state rule, for each of the values of the external environment feature amount data, based on the line of the state labels set in step S203.

Step S205: The action label setting unit 23 classifies the feature amount data obtained in step S201 into groups for each of the values of the feature amount data, and sets an action label to each of the classified groups.

Step S206: The action rule identifying unit 24 identifies an action rule, for each of the values of the external environment feature amount data, based on the line of the action labels set in step S205.

Step S207: The state rules identified in step S204 and the action rules identified in step S206 are put in correspondence with each other and output for each of the values of the external environment feature amount data. Then, the process ends.

In the following, a description will be specifically made for the case that the observation data storing unit 101 stores object observation data, which are a motion picture of a squirrel taken by a camera. In this specific example, it is assumed that the camera was located so that the camera was able to take all the inside of a squirrel cage from above the cage. It is assumed that the feature amount data obtaining unit 102 has obtained the feature amount data “A, B, C, C, C, C, A, . . . ” about a position of the squirrel and the feature amount data “Z, Z, Y, Z, Z, X, Y, . . . ” about a posture of the squirrel by conducting a background differencing process of the object observation data, which was a motion picture. Note that it is assumed that in this specific example, the pattern of “C, C, C, C” periodically appeared in the feature amount data about the position of the squirrel, and the pattern “Z, Z, X” periodically appeared in the feature amount data about the posture of the squirrel in the same period as when the pattern “C, C, C, C” appeared. Here, it is assumed that “C” is the value of the feature amount data representing the position of a litter box, “Z” is the value of the feature amount data representing lying low, and “X” is the value of the feature amount data representing looking around. The state rule obtaining unit 103 obtains the state rule “C, C, C, C” from the feature amount data about the position of the squirrel. Then, the action rule obtaining unit 104 obtains the action rule “Z, Z, X” corresponding the state rule “C, C, C, C.” Then, the output unit 105 outputs the obtained state rule and action rule. Note that, it is assumed that in this specific example, the output state rule “C, C, C, C” represents staying in the litter box, and the output action rule “Z, Z, X” represents looking around after lying low for a short time.

In addition, a description will be specifically made for the case that the observation data storing unit 101 stores the object observation data, which are a motion picture of the squirrel taken by the camera and the object observation data, which is the sound of a call made by the squirrel collected by a microphone. In this specific example, some of the descriptions redundant to the specific example described before are not described. In this specific example, it is assumed that the microphone was located in the vicinity of the squirrel cage. It is assumed that the feature amount data obtaining unit 102 has obtained the feature amount data “A, B, C, C, C, C, A, . . . ” about a position of the squirrel, and the feature amount data “Z, Z, Y, Z, Z, X, Y, . . . ” about a posture of the squirrel by conducting a background differencing process of the object observation data, which is a motion picture and the feature amount data “0, 0, 0, 0, 0, 1, 0, . . . ” about whether the squirrel made a call or not from the object observation data, which are sound (step S201). Note that, it is assumed that in this specific example, the pattern “0, 0, 1” also appeared periodically in the period when the pattern “Z, Z, X” appeared in the period when the pattern “C, C, C, C” appeared. Here, it is assumed that “0” is the value of the feature amount data indicating that the squirrel is not crying, and “1” is the value of the feature amount data indicating that the squirrel is crying. The state rule obtaining unit 103 obtains a state rule “C, C, C, C” from the feature amount data about the position of the squirrel (from step S203 to step S204). Then, the action rule obtaining unit 104 obtains an action rule [“Z, Z, X” “0, 0, 1”] corresponding to the state rule “C, C, C, C” (from step S205 to step S206). Then, the output unit 105 outputs the obtained state rule and the obtained action rule. Note that, it is assumed that the state rule “C, C, C, C” and the action rule [“Z, Z, X” “0, 0, 1”] both output in this specific example indicate that the squirrel stays in the litter box and that the squirrel is crying while looking around after lying low for a short time, respectively.

As described above, according to the embodiment, the feature amount data obtaining unit 102 obtains two or more sets of feature amount data from one type of time-series data. With this operation, a rule of an object for observation can be obtained from a plurality of point of view, whereby data in time series can be used effectively to obtain the rule. Further, according to the embodiment, the feature amount data obtaining unit 102 can obtain the external environment feature amount data. With this operation, the state rule and the action rule can be obtained for each of the values of the external environment feature amount data, or each of the classes of the values of the external environment feature amount data. For example, in the case that the feature amount data obtaining unit 102 obtains the external environment feature amount data, search criteria can be limited in the apparatus and the like for classifying data based on a state and an action of an object by using a rule and the like, thereby a rule can be accurately searched. Further, according to the embodiment, the feature amount data obtaining unit 102 can obtain two or more types of feature amount data from one type of observation data. With this operation, it is possible to obtain the feature amount data appropriate to obtain the state rule and to obtain the feature amount data appropriate to obtain the action rule. In the case that the feature amount data obtaining unit 102 obtains two or more types of feature amount data from one type of observation data, the search criteria can be limited, for example, in the apparatus and the like for classifying data based on a state and an action of an object by using a rule, whereby a rule can be searched at high speed. Further, according to the embodiment, the state label setting unit 21 can set labels to the feature amount data. With this arrangement, when obtaining the state rule, it is possible to obtain the state rule by classifying the observation data into feature amount groups. Thus, for example, the state rule based on the rounded values of the observation data can be obtained. For example, in the apparatus and the like for classifying data based on a state and an action of an object by using a rule, a similar rule can be searched at high speed. Further, according to the embodiment, the action label setting unit 23 can set labels to the feature amount data. With this operation, when obtaining the action rules, it is possible to obtain the action rule by classifying the observation data into feature amount groups. Thus, for example, the action rule based on the rounded value of the observation data can be obtained. For example, in the apparatus and the like for classifying data based on a state and an action of an object by using a rule, a similar rule can be searched at high speed. Further, according to the embodiment, the state rule obtaining unit 103 and the action rule obtaining unit 104 can obtain the state rule and the action rule from the observation data constituted by an image taken of an animal or by collected sound made by the animal.

The description has been made for the case that the state label setting unit 21 and the state rule identifying unit 22 are included; however, the time-series data analyzing apparatus 1 does not have to include the state label setting unit 21 or the state rule identifying unit 22. In the case that neither the state label setting unit 21 nor the state rule identifying unit 22 is included, the state rule obtaining unit 103 may be made to obtain the state rule from the feature amount data without setting any labels.

The description has been made for the case that the action label setting unit 23 and the action rule identifying unit 24 are included; however, the time-series data analyzing apparatus 1 does not have to include the action label setting unit 23 or the action rule identifying unit 24. In the case that neither the action label setting unit 23 nor the action rule identifying unit 24 is included the action rule obtaining unit 104 may be made to obtain the action rule from the feature amount data without setting any labels.

The software for realizing the time-series data analyzing apparatus 1 in the embodiment is a program as described below. The program makes a computer which can access an observation data storing unit storing one or more types of observation data in time series, which are observation data of an object for observation, function as: a feature amount data obtaining unit for obtaining two or more types of feature amount data which are time series data of characteristic values, from one type of observation data stored in the observation data storing unit; a state rule obtaining unit for obtaining a state rule which is a rule related to a state of the object, by using feature amount data; an action rule obtaining unit for obtaining an action rule which is a rule related to an action of the object, by using the feature amount data; an output unit for outputting the state rule obtained by the state rule obtaining unit and the action rule obtained by the action rule obtaining unit.

Note that in the embodiment, the processes (functions) may be realized by being centralized processing by one device (system) or may be realized by distributed processing by a plurality of devices. Further, it goes without saying that in the embodiment, two or more communication unit in one device can be physically realized by one unit.

In the embodiment, the component may be configured with dedicated hardware, or a component which can be realized by software may be realized by performing a program. For example, the components can be realized by causing a program execution unit such as a CPU to read out and execute software programs recorded in a recording medium such as a hard disk and a semiconductor memory.

Note that in the above programs, functions to be realized by the above programs do not include a function which can be realized only by hardware. For example, the functions realized only by the above programs do not include an obtaining unit for obtaining information or functions which can be realized only by hardware such as a modem and an interface card in the output unit for outputting information and the like.

FIG. 7 is a schematic diagram illustrating an example of an external appearance of a computer which executes the above programs to realize the present invention according to the above embodiment. The above embodiment can be realized by a computer hardware and a computer program to be executed on the computer hardware.

In FIG. 7, a computer system 1100 is equipped with a computer 1101 including a CD-ROM drive 1105 and an FD drive 1106, a keyboard 1102, a mouse 1103, and a monitor 1104.

FIG. 8 is a diagram illustrating an internal configuration of the computer system 1100. In FIG. 8, the computer 1101 is equipped with, in addition to the CD-ROM drive 1105 and the FD drive 1106, an MPU 1111; a ROM 1112 for storing programs such as a boot program; a RAM 1113 which is connected to the MPU 1111, temporarily stores instructions of an application program, and provides a temporary storage space; a hard disk 1114 for storing the application program, a system program, and data; and a bus 1115 for connecting between the MPU 1111, the ROM 1112, and the like. The computer 1101 may include a network card (not shown in the drawings) for providing connection to a LAN.

The program for making the computer system 1100 perform the functions of the present invention according to the above embodiment and others may be stored in a CD-ROM 1121 or an FD 1122, and may be inserted in the CD-ROM drive 1105 or the FD drive 1106 to be transferred to the hard disk 1114. Instead of this manner, the program may be transferred to the computer 1101 through a network (not shown in the drawings) to be stored in the hard disk 1114. The program is loaded on the RAM 1113 when executed. The program may be loaded directly from the CD-ROM 1121, the FD 1122, or the network.

The program does not have to include an operating system (OS) for making the computer 1101 perform the functions of the present invention according to the above embodiment, a third-party program, or the like. The program may include only a part of instructions for calling an appropriate function (module) in a controlled manner to obtain an intended result. It is well known how the computer system 1100 operates, and a detailed description thereof will not be made.

Further, the term “unit” in the various units of the present invention may be read as a “section” or a “circuit.”

As described above, since the time-series data analyzing apparatus and the like according to the present invention obtains two or more types of feature amount data from one type of time-series data, rules about an object for observation can be obtained from a plurality of points of view, whereby the time-series data can be effectively used to obtain the rules. This advantage is helpful for a time-series data analyzing apparatus and the like used in an apparatus and the like for classifying data based on a state and an action of an object by using a rule.

With a time-series data analyzing apparatus and the like according to an embodiment of the present invention, two or more sets of feature amount data are obtained from one type of time-series data; thus rules about an object for observation can be obtained from a plurality of points of view, whereby the data in time series can be effectively used to obtain the rules.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A time-series data analyzing apparatus comprising:
an observation data storing unit configured to store one or more types of observation data in time series which are observation data of an object for observation;
a feature amount data obtaining unit configured to obtain two or more types of feature amount data which are time series data of characteristic values, from one type of the observation data stored in the observation data storing unit;
a state rule obtaining unit configured to obtain a state rule which is a rule related to a state of the object, by using the feature amount data;
an action rule obtaining unit configured to obtain an action rule which is a rule related to an action of the object, by using the feature amount data; and
an output unit configured to output the state rule obtained by the state rule obtaining unit and the action rule obtained by the action rule obtaining unit.

2. The time-series data analyzing apparatus according to claim 1, wherein
the observation data storing unit stores two or more types of observation data in time series,
the feature amount data obtaining unit obtains three or more types of feature amount data from the two or more types of observation data stored in the observation data storing unit,
the state rule obtaining unit obtains the state rule by using any N or more types of feature amount data of the three or more types of feature amount data, where N is one or two, and
the action rule obtaining unit obtains the action rule by using any (3-N) or more types of feature amount data of the three or more types of feature amount data.

3. The time-series data analyzing apparatus according to claim 1, wherein
the observation data storing unit stores also observation data in time series about an external environment,
the feature amount data obtaining unit obtains external environment feature amount data which are time series data of characteristic values, also from the observation data in time series about the external environment,
the state rule obtaining unit obtains a state rule for each of values of the external environment feature amount data or each of classes of the values of the external environment feature amount data,
the action rule obtaining unit obtains an action rule for each of the values of the external environment feature amount data or each of the classes of the values of the external environment feature amount data, and
the output unit outputs the state rule and the action rule for each of the values of the external environment feature amount data or for each of the classes of the values of the external environment feature amount data.

4. The time-series data analyzing apparatus according to claim 1, wherein the state rule obtaining unit comprises:
a state label setting unit configured to classify values of the feature amount data into a plurality of groups and set the same state label to the value of the feature amount data belonging to the same group; and
a state rule identifying unit configured to obtain a state rule based on the state labels set by the state label setting unit.

5. The time-series data analyzing apparatus according to claim 1, wherein the action rule obtaining unit comprises:
an action label setting unit configured to classify values of the feature amount data into a plurality of groups and set the same action labels to the values of the feature amount data belonging to the same group; and
an action rule identifying unit configured to obtain an action rule based on the action labels set by the action label setting unit.

6. The time-series data analyzing apparatus according to claim 1, wherein the object is an animal, and
the observation data includes image data constituted by image data taken of the animal and sound data constituted by collected sound made by the animal.

7. A time-series data analyzing method comprising:
firstly obtaining two or more types of feature amount data which are time series data of characteristic values, from one type of the observation data stored in an observation data storing unit, the observation data storing unit storing one or more types of observation data in time series which are observation data of an object for observation;
secondly obtaining a state rule which is a rule related to a state of the object, by using the feature amount data;
thirdly obtaining an action rule which is a rule related to an action of the object, by using the feature amount data; and
outputting the state rule obtained in the secondly obtaining and the action rule obtained in the thirdly obtaining.

8. A computer-readable recording medium having stored therein a program, the program causing a computer to execute a process comprising:
firstly obtaining two or more types of feature amount data which are time series data of characteristic values, from one type of observation data stored in an observation data storing unit, the observation data storing unit storing one or more types of observation data in time series which are observation data of an object for observation;
secondly obtaining a state rule which is a rule related to a state of the object, by using the feature amount data;
thirdly obtaining an action rule which is a rule related to an action of the object, by using the feature amount data; and
outputting the state rule obtained in the secondly obtaining and the action rule obtained in the thirdly obtaining.
